(19) United States
(12) Patent Application Publication
(10) Pub. No.: US 2016/0088837 A1
(43) Pub. Date: Mar. 31, 2016

(54) MICROCAPSELS CONTAINING AN ALGICIDE AND A MELAMINE-FORMALDEHYDE POLYMER

(71) Applicant: LANXESS DEUTSCHLAND GMBH, Köln (DE)

(72) Inventors: Hermann UHR, Leverkusen (DE); Katrin MOEWS, Dortmund (DE)

(21) Appl. No.: 14/889,164

(22) PCT Filed: May 7, 2014
(86) PCT No.: PCT/EP2014/059316

§ 371 Date: Nov. 5, 2015

(30) Foreign Application Priority Data
May 8, 2013 (EP) 13167028.3

(51) Int. Cl. A01N 25/28; A01N 47/30

(52) U.S. Cl. CPC A01N 25/28; A01N 47/30

(57) ABSTRACT

The present invention relates to microcapsules comprising one or more biocides such as, in particular, algicides, and at least one melamine-formaldehyde polymer, to a method for the production thereof, and to the use thereof for protecting technical materials.

The present invention relates to microcapsules comprising one or more biocides such as, in particular, algicides, and at least one melamine-formaldehyde polymer, to a method for the production thereof, and to the use thereof for protecting technical materials.

Some urea derivatives such as, for example, diuron (3-(3,4-dichlorophenyl)-1,1-dimethylurea) are known for their algaetoxic effect and are used as algicide in coating compositions such as, for example, in exterior paints in order to prevent algae infestation on external walls. In the coating compositions industry, high demands are placed on the algicides used for the equipping of coating compositions. The coating compositions must, for example, also remain stable upon frequent contact with water and not be subjected to any discoloration. Since some algicides such as, for example, diuron are water-soluble, as a result of contact of the exterior paint, for example with hail, the algicide is washed out of the paints (also called “leaching”). This results in an undesired reduction in the algaetoxic effect and also in a considerable local impact on the environment with algicides. This leaching should be low so that the external paint and the external walls are protected for a long time against algae infestation. One option for reducing leaching is the use of microencapsulations.

The prior art discloses coating compositions protected against microbiological infestation and also methods for producing microencapsulated biocides.

Thus, for example, WO04000953A1 describes a coating composition for protection against microorganism infestation of surfaces which are subjected to the effect of moisture or water, where the coating composition either itself has a pH of at least 11.0 or is provided for the coating of a substrate material whose pH is at least 11.0. The coating composition is characterized in that it comprises a biocide which is bonded in a carrier material made of solids particles and is released therefrom in a delayed manner.

DE102006061890A1 describes sealing compositions which comprise, as biocide, for example 2n-octyl-4-isothiazolin-3-one and optionally one or more different biocides, where the biocide is enclosed in microparticles made of, for example, an aminoplastic resin.

It is known from DE10133545A1 to treat sealing compositions with specific benzothiophene fungicide preparations in order to prevent the polymer compositions from turning moldy. In this connection, reference is also made to the difficulty of finding suitable fungicides for sealing compositions which are stable and are not susceptible to being washed out. Consequently, the biocides employed have to be used in high concentrations, which can also lead to an impact on the environment.

It is known from JP2002053412A2 that biocides can be enclosed in a resin matrix. Thus, the enclosure of 2-n-octyl-4-isothiazolin-3-one in a styrene-maleic anhydride resin is described in this document.

EP0758633A1 describes porous granules which can comprise chemical substances such as, for example, also biocides, which said granules slowly release during use.

JP2004099557A2 describes fine particles of biocide-containing resins which are used for suppressing the growth of microorganisms, particularly in aqueous emulsion paints.

Although microencapsulations of diuron analogous to methods of the prior art of microencapsulated biocides exhibit a reduction in leaching, some have high proportions of free formaldehyde, which considerably hinder commercial use.

The prior art furthermore reveals that it is not directly possible to provide microcapsules with a satisfactory algaetoxic effect coupled with a low leaching rate and high storage stability.

It was therefore the object of the present invention to provide microcapsules which permit improved protection of coating compositions against algae infestation.

The solution to the problem and the subject matter of the present invention are then microcapsules comprising
at least one compound of the formula (I)

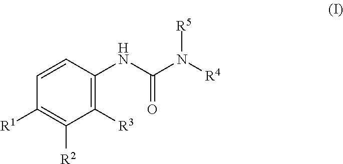

where
R¹ and R², independently of one another, are hydrogen, chlorine, bromine, alkyl, alkoxy, trifluoromethyl or aryloxy,
R³ is hydrogen, chlorine, bromine, fluorine or alkyl and
R⁴ and R⁵, independently of one another, are alkyl or alkoxy.
   where the compound of the formula (I) is microencapsulated with at least one melamine-formaldehyde polymer.

The scope of the invention encompasses all of the parameters and explanations above and hereinbelow, specified in general terms or in preferred ranges, with one another, thus also between the respective ranges and preferred ranges in any desired combination.

The microcapsules according to the invention comprise at least one compound of the formula (I).

Alkyl means a branched or straight-chain, cyclic or acyclic alkyl radical. Preferably, alkyl is (C₁-C₁₀)-alkyl, particularly preferably (C₁-C₄)-alkyl such as, for example, methyl, ethyl, n-propyl, isopropyl, n-butyl, isobutyl, sec-butyl or tert-butyl.

Alkoxy is a branched or a straight-chain alkoxy radical. Preferably, alkoxy is (C₁-C₁₀)-alkoxy, particularly preferably (C₁-C₄)-alkoxy such as, for example, methoxy, ethoxy, n-propoxy, isopropoxy, n-butoxy, isobutoxy, sec-butoxy or tert-butoxy.

Aryloxy is a substituted aryloxy group, preferably phenoxy, or an unsubstituted aryloxy group, preferably phenoxy substituted by alkoxy, in particular by methoxy.

R¹ and R² are preferably, independently of one another, hydrogen, chlorine, bromine, methyl, isopropyl, methoxy, trifluoromethyl, phenoxy or para-methoxyphenoxy.

R³ is preferably hydrogen.

R⁴ and R⁵ are preferably, independently of one another, methyl, methoxy or butyl.

Examples of particularly preferred compounds of the formula (I) are 3-(4-bromo3-chlorophenyl)-1-methoxy-1-methylurea (chlorbromuron), 3-(3-chloro-4-methylphenyl)-1,1-dimethylurea (chlortoluron), 3-(3,4-dichlorophenyl-1,1-dimethylurea (diuron), 3-(4-(4-methoxyphenoxy)phenyl)-1,1-dsmethylurea (difenoxuron), 1,1-dimethyl-3-[3-(trifluoromethyl)phenyl]urea (fluometuron), 3-(4-isopropylphenyl)-1,1-dimethylurea (isoprofuron) and 1-butyl-3(3,4-dichlorophenyl)-1-methylurea (neburon). Very particular preference is given to diuron.

The compounds of the formula (I) per se are known and can be produced by methods known in the literature or be acquired commercially.

The microencapsulation of the compounds of the formula (I) takes place by means of microencapsulation material. In the context of this invention, microencapsulation means the at least partial, preferably complete, enveloping of the compounds of the formula (I) according to the invention with microencapsulation material.

The microcapsules according to the invention are notable for the fact that they have for example a volume-averaged particle size of 0.3 to 100 μm. Preferably, the microcapsules according to the invention have a volume-averaged particle size of 5 to 40 μm. Moreover, the microcapsules according to the invention are notable for the fact that the D90 value, determined via laser diffraction as volume-weighted distribution as described in the experimental section, Is preferably less than 40 μm.

The microcapsules according to the invention comprise at least one melamine-formaldehyde polymer as microencapsulation material. The term melamine-formaldehyde polymer is to be understood as meaning a polymer in which melamine has been polycondensed, typically with formaldehyde in molar excess.

General methods for producing microencapsulations, in particular also for producing microencapsulations of melamine-formaldehyde polycondensates, are known (see for example C. A. Finch, R. Bodmeier, Microencapsulation, Ullmann's Encyclopedia of Industrial Chemistry, 8th edition 2001, Electronic Release).

The microencapsulation material of the microcapsules according to the invention can, for example, also comprise other synthetic, semisynthetic or natural aminoplastic resins. Aminoplastic resins are generally understood as meaning polycondensation products of carbonyl compounds with compounds containing NH groups. Of particular interest in this connection are melamine-formaldehyde resins modified with urea or phenol (melamine-urea-formaldehyde resins, melamine-phenol-formaldehyde resins). Further possible aminoplastic resins that can be added to the melamine-formaldehyde resin are, for example, aminoplastic resins made of a compound containing NH groups and acetaldehyde or glyoxal. Furthermore, urethane resins, cyanamide resins or dicyanamide resins, aniline resins, sulfonamide resins or mixtures of these resins can be added. These resins and their production are known to the person skilled in the art.

In a further embodiment, preferred synthetic materials for the microencapsulation material are, for example, acrylic polymers and copolymers, polyacrylamide, polyalkyl cyanoacrylate, and poly(ethylene vinyl acetate), aluminum monostearate, carboxyvinyl polymers, polyamides, poly(methyl vinyl ether-maleic anhydride), poly(adipyl-L-lysine), polycarbonates, polyterephthalamide, poly(vinyl acetate phthalate), poly(terephthaloyl-L-lysine), polyarylsulfones, poly(methyl methacrylate), poly(ε-caprolactone), polyvinylpyrrolidone, polydimethylsiloxane, polyoxyethylenes, polyesters, polyglycolic acid, polylactic acid and copolymers thereof, polyglutamic acid, polylysine, polystyrene, poly(styrene-acrylonitrile), polyimides and polyvinyl alcohol.

In a further embodiment, preferred semisynthetic materials for the microencapsulation material are, for example, cellulose acetate, cellulose acetate butyrate, cellulose acetate phthalate, cellulose nitrate, ethylcellulose, hydroxypropylcellulose, sodium carboxymethylcellulose, hydroxypropylmethylcellulose, methylcellulose, hydroxypropylmethylcellulose phthalate, hydrogenated tallow, myristyl alcohol, glycerol mono- or dipalmitate, hydrogenated castor oil, glyceryl mono- and tristearates and 12-hydroxystearyl alcohol.

in a further embodiment, preferred natural materials for the microencapsulation material are, for example, gum arable, agar, agarose, maltodextrin, sodium alginate, calcium alginate, dextran, fats, fatty acids, cetyl alcohol, milk solids, molasses, gelatin, gluten, albumin, shellac, starches, caseinates, stearins, saccharose, and waxes, such as beeswax, carnauba wax and spermaceti wax.

In general, up to 50% by weight, based on the total weight of microencapsulation material, of different synthetic, semisynthetic or natural aminoplastic resins can be added to the melamine-formaldehyde polymer. Preferably, the microencapsulation material, however, comprises at least 95% by weight of melamine-formaldehyde polymer, particularly preferably at least 99% by weight of melamine-formaldehyde polymer.

in general, the weight ratio (w/w) of the microencapsulation material to compounds of the formula (I) in microcapsules according to the invention is from 1:100 to 100:1, preferably from 1:10 to 10:1 and very particularly preferably from 1:4 to 2:1.

The invention also encompasses a method for producing the microcapsules according to the invention, characterized in that it comprises at least the following steps:
a) deposition of microencapsulation material containing melamine-formaldehyde polymer on compounds of the formula (I) and then
b) treatment at a temperature of 50 to 95° C.,

In the a method according to the invention for producing the microcapsules according to the invention, for example, a solution of the at least one compound of the formula (I) can be used for example in a water-immiscible solvent which is then emulsified. Preferably, an aqueous suspension or emulsion of the compounds of the formula (I) is used when producing the microcapsules according to the invention.

The method involves the use of melamine-formaldehyde polymers which are deposited by changing the pH on compounds of the formula (I) and are thermally treated and thus form the microcapsules. The melamine-formaldehyde polymers are commercially available, for example Saduren® (BASF AG), Maprenal® (Ineos Melamines), Quecodur® (Thor GmbH), or can also be produced from melamine and formaldehyde by known methods, as described for example in WO 2008/000797 A2.

Further auxiliaries known to the person skilled in the art, such as, for example, protective colloids, can also be added to the melamine-formaldehyde polymer.

Water-soluble polymers can be used as protective colloids in the method according to the invention. If protective colloids are used, then preference is given to using polyacrylates, preferably Coadis® BR3 (Coatex), partially saponified polyvinyl acetate, polyvinyl alcohol, polyvinylpyrrolidone, cellulose ethers (tylose), such as, for example, methylcellulose, hydroxyethylcellulose or hydroxypropylmethylcellulose, starch, proteins, gum arabic, alginates, pectins, gelatins or mixtures of these compounds. As protective colloid, particular preference is given to using a mixture of gum arabic and polyacrylate.

The melamine-formaldehyde polymer dissolved in the water is generally precipitated by establishing an acidic pH and is deposited on the surface of the compounds of the formula (I).

Suitable conditions for the deposition of the polymer on the compounds of the formula (I) can be determined experimentally in a few preliminary experiments without great effort. For example, the deposition can take place at a pH in the range from 0 to 6.99, preferably from 1.0 to 4.0, particularly preferably from 2.50 to 3.50 and very particularly preferably from 2.80 to 3.20, measured under standard conditions of 20° C.

To establish the pH, both inorganic and organic acids can be used, such as, for example, hydrochloric acid, sulfuric acid, phosphoric acid or citric acid, oxalic acid, acetic acid, formic acid, acidic salts or mixtures thereof.

The addition of the polymer to the solution of the compounds of the formula (I) can take place, for example, directly or over a period of at least one minute, preferably over a period of at least 30 minutes to 24 hours, particularly preferably over a period of at least one hour and very particularly preferably over a period of at least 2 to 6 hours.

In the method according to the invention for producing the microcapsules according to the invention, the deposition temperature of the melamine-formaldehyde polymers can be varied within a broad range, the deposition preferably taking place at a temperature of 40 to 80° C., particularly preferably in a range from 50 to 70° C. and very particularly preferably at a temperature of 56 to 64° C.

In the method according to the invention for producing the microcapsules according to the invention, a subsequent thermal treatment takes place. Without wishing to be restricted scientifically in any form, it is assumed that not yet crosslinked or not yet polymerized groups are crosslinked or polymerized as a result of the thermal treatment. Following the deposition of the melamine-formaldehyde polymer, a treatment of the deposited melamine-formaldehyde polymer can take place at temperatures which are lower, the same as or higher than the deposition temperature. Preferably, the treatment takes place with stirring. The microcapsules according to the invention can also be chemically treated in an alternative embodiment.

Preferably, the treatment of the microcapsules according to the invention takes place at a temperature that is increased compared to the deposition temperature, over a period of more than one hour.

Furthermore, the treatment of the microcapsules according to the invention preferably takes place at temperatures of 50 to 95° C. over a period of at least one hour, particularly preferably at temperatures of 70 to 95° C., over a period of at least one hour, preferably over a period of 1 to 48 hours, preferably 3 to 24 hours, alternatively 1 to 8 hours or 2 to 6 hours, and yet further preferably at temperatures of 30 to 90° C. over a period of at least one hour, preferably over a period of from 1 to 48 hours, preferably 3 to 24 hours, alternatively 1 to 8 hours, or 2 to 6 hours.

In the method according to the invention for producing the microcapsules according to the invention, it is possible to introduce a suspension or emulsion of the compounds of the formula (I) and of the melamine-formaldehyde polymer with optionally auxiliaries, such as, for example, protective colloids or else also further aminoplastic resins, to heat to the deposition temperature and to establish the aforementioned pH so that the resin precipitates out.

In an alternative embodiment, it is possible to add urea to a suspension or emulsion of the compounds of the formula (I) for the purpose of producing the microcapsules according to the invention. The urea addition can take place for example before the thermal treatment. In an alternative embodiment, the addition of the urea can also take place directly after the thermal treatment. In a further alternative embodiment, the addition of the urea can take place in the course of a formulation with other auxiliaries, such as, for example, pack preservatives and emulsifiers, after the thermal treatment. Preferably, the urea is added after the thermal treatment in the course of a formulation with further auxiliaries.

The amount of urea added is, for example, from 0.1 to 20% by weight, preferably 1 to 10% by weight, particularly preferably 2 to 5% by weight, based on the total amount of encapsulation material used.

In an alternative embodiment, however, it is likewise possible to firstly introduce a suspension or emulsion comprising at least one compound of the formula (I) optionally mixed with auxiliaries such as, for example, protective colloids, then to establish the pH, then to heat the mixture and then to add the melamine-formaldehyde polymer. Preferably, the microcapsules according to the invention produced in accordance with the method according to the invention are then treated with stirring at elevated temperature.

The method according to the invention for producing the microcapsules according to the invention can be carried out at any desired pressures. Preferably, the method according to the invention for producing the microcapsules according to the invention is carried out at ambient pressure.

The microcapsules according to the invention can then, for example, be isolated by filtration and dried at room temperature or by means of gentle heating. However, there is also the option to dry the microencapsulation material by spray-drying or freeze-drying and then to isolate it. Preferably, the microcapsules according to the invention are separated off by filtration and then dried.

The invention further relates to microcapsules comprising
at least one compound of the formula (I)

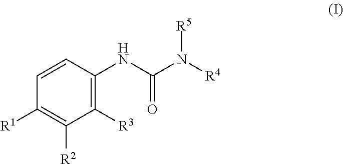

where
R¹ and R², independently of one another, are hydrogen, chlorine, bromine, alkyl, alkoxy, trifluoromethyl or aryloxy,
R³ is hydrogen, chlorine, bromine, fluorine or alkyl and
R⁴ and R⁵, independently of one another, are alkyl or alkoxy,
   where the compound of the formula (I) is microencapsulated with at least one melamine-formaldehyde polymer,
   with a 24 h leaching rate of 0.1 to 9.0 parts per million (ppm), preferably from 0.1 to 5.0 ppm, particularly preferably from 0.1 to 3.0 ppm and very particularly preferably less than 2.5 ppm, determined by means of a 24 h leaching test as given in the examples.

The invention further relates to microcapsules according to the above definition which alternatively or additionally have a 96 h leaching rate of 0.1 to 9.0 parts per million (ppm), preferably from 0.1 to 6.0 ppm, particularly preferably from 0.1 to 5.0 ppm and very particularly preferably less than 2.5 ppm, determined by means of a 96 h leaching test as given in the examples.

Microcapsules with the aforementioned leaching rate are obtainable for example by the method according to the invention.

The microcapsules according to the invention are particularly suitable for use in or as biocidal, in particular algicidal, compositions. Consequently, biocidal compositions containing microcapsules according to the invention are also encompassed by the invention, as is the use of the microcapsules according to the invention as biocidal composition or in biocidal compositions.

The microcapsules according to the invention are notable for high efficacy and their broad activity spectrum towards algae, cyanobacteria and other photoautotrophic microorganisms.

Algae are preferably prokaryotic algae (cyanophyta, blue algae) such as, for example, representatives from the subclass Coccogoneae and the subclass Hormogoneae.

By way of example, from the order Chroococcales, mention may be made of species of the genera Synechococcus, Chroococcus, Gloeocapsa, Aphanocapsa, Aphanothece, Microcystis and Merismopedia; from the orders Chamaesiphonales and Pleurocapsales species of the genera Chamaesiphon and Dermatocarpa; from the order Oscillatoriales species of the genera Phormidium, Schizothrix, Spirulina, Plectonema and Lyngbya; from the order Nostocales species of the genera Nostoc, Rivularia, Tolypothrix, Scytonema, Anabaenopsis, Calothrix and Aulosira; from the order Stigonematatles species of the genera Stigonema, Fischeralla, Hapalosiphon and Mastigocladus.

Furthermore, the compounds also exhibit good efficacy toward eukaryotic representatives from the divisions Heterokontophyta, Rhodophyta, Chlorophyta, Euglenophyta, Cryptophyta, Dinophyta and Haptophyta.

By way of example, from the class of Xanthophyceae mention may be made of species of the genera Tribonema and Vaucheria; from the class Chrysophyceae species of the genera Chrysocapsa, Rhizochrysis, Chrysosphaera, Phaeothamnion and Thallochrysis; from the class Phaeophyceae (brown algae) species of the genera Ectocarpus, Pylaiella, Cutleria, Zanardinia, Dictyota, Padina, Dictyopteris, Laminaria, Macrocystis, Lessonia, Nerocystis, Chorda, Alaria, Fucus, Ascophyllum, Himanthalia, Sargassum, Cystoseira, Halidrys, Pelvetia, Coccophora and Durvilla; from the class Rhodophyceae (red algae) species of the genera Porphyridum, Bangia, Porphyra, Corallina, Lithothamnia, Lithophyllum, Rhodymania, Delesseria, Grinnellia, Platysiphonia, Polysiphonia, Ceramium, Plumaria, from the class Chlorophyceae (green algae) species of the genera Chlorococcum, Chlorella, Spongiochloris, Monostroma, Ulva, Enteromorpha, Ulothrix, Trentepohlia, Apatococcus, Desmococcus, Cladophora, Siphonocladus, Valonia, Caulerpa, Bryopsis, Acetabularia, Halimeda and Tuna, and also Chlamydomonas, Microspora, Platymonas, Pleurococcus, Scenedesmus, Stichococcus, Trentepophila, Anacystis, Gleocapsa, Mycrocystis, Oscillatoria, Scytonema.

The biocidal compositions according to the invention can be present in any desired formulation, such as, for example, in the form of suspension concentrates, water-dispersible powders, water-dispersible granules or simple powder mixtures, preference being given to suspension concentrates, powder mixtures and water-dispersible granules.

In principle, preferred types of formulation are essentially dependent on the intended use and the physical properties required for this. However, since these are known, it is customary practice for the person skilled in the art to ascertain a preferred type of formulation in a few experiments.

The formulations can additionally also comprise yet further substances, such as stabilizers, pack preservatives and further blocides, such as, for example, fungicides, algicides, insecticides, acaricides, nematicides, radicides and herbicides or mixtures thereof, preferably fungicides or algicides or mixtures thereof, very preferably algicides.

Besides the microcapsules according to the invention, the biocidal compositions can optionally further comprise various auxiliaries. For the auxiliaries specified below, there is in each case independently of the others also the option that they are not present. Possible auxiliaries are, for example:
Interface-active substances, such as, for example, surfactants. Surfactants can be for example nonionic, cationic or amphoteric surfactants, preferably anionic surfactants. Anionic surfactants are, for example, alkyl sulfates, alkyl ether sulfates, alkyl aryl sulfonates, alkyl succinates, alkyl sulfosuccinates, N-alkoyl sarcosinates, acyl taurates, acyl isethionates, alkyl phosphates, alkyl ether phosphates, alkyl ether carboxylates, alpha-olefinsulfonates, in particular the alkali metal and alkaline earth metal salts, for example sodium, potassium, magnesium, calcium, and ammonium and triethanolamine salts. The alkyl ether sulfates, alkyl ether phosphates and alkyl ether carboxylates can in each case have for example from 1 to 10 ethylene oxide or propylene oxide units, preferably 1 to 3 ethylene oxide units. Of suitability are, for example, sodium lauryl sulfate, ammonium lauryl sulfate, sodium lauryl ether sulfate, ammonium lauryl ether sulfate, sodium lauryl sarcosinate, sodium oleyl succinate, ammonium lauryl sulfosuccinate, sodium dodecylbenzenesulfonate, triethanolamine dodecylbenzenesulfonate. The biocidal compositions according to the invention can in this connection comprise for example from 0.01 to 10% by weight preferably from 0.2 to 8% by weight, particularly preferably from 0.3 to 5% by weight and very particularly preferably from 0.5 to 3% by weight, of interface-active substances.
Antifoams. The antifoams used are generally interface-active substances which are only weakly soluble in the surface-active solution. Preferred antifoams are those which are derived from natural fats and oils, petroleum derivatives or silicone oils.
Wetting agents, such as, for example, alkali metal, alkaline earth metal, ammonium salts of aromatic sulfonic acids, for example ligno-, phenol-, naphthalene- and dibutylnaphthalenesulfonic acid, and also of fatty acids, alkyl- and alkylarylsulfonates, alkyl, lauryl ether and fatty alcohol sulfates, and salts of sulfated hexa, hepta- and octadecanols or fatty alcohol glycol ethers, condensation products of sulfonated naphthalene and its derivatives with formaldehyde, condensation products of naphthalene or of the naphthalenesulfonic acids with phenol and formaldehyde, polyoxyethylene octyl phenol ether, ethoxylated isooctyl-, octyl- or nonylphenol, alkylphenol or tributylphenyl polyglycol ether, tris-sterylphenyl ether ethoxylates, alkylaryl polyether alcohols, isotridecyl alcohol, fatty alcohol ethylene oxide condensates, ethoxylated castor oil, polyoxyethylene alkyl ethers or polyoxypropylane, lauryl alcohol polyglycol ether acetate, sorbitol esters, lignosulfite waste liquors or methylcellulose. The biocidal compositions according to the invention can in this connection comprise for example from 0.01 to 8% by weight, preferably from 0.2 to 6% by weight, particularly preferably from 0.3 to 5% by weight and very particularly preferably from 0.5 to 3% by weight, of wetting agents.
Emulsifiers, such as, for example, sodium, potassium and ammonium salts of straight-chain aliphatic carboxylic acids of chain length C₁₀-C₂₀, sodium hydroxyoctadecanesulfonate, sodium, potassium and ammonium salts of hydroxy fatty acids of chain length C₁₀-C₂₀ and the sulfation or acetylation products thereof, alkyl sulfates, also as triethanolamine salts, alkyl-(C₁₀-C₂₀)-sulfonates, alkyl-(C₁₀-C₂₀)-arylsulfonates, dimethyldialkyl-(C₈-C₁₈)-ammonium chloride, acyl, alkyl, oleyl and alkylaryl oxethylates and their sulfation products, alkali metal salts of the sulfosuccinic acid esters with aliphatic saturated monohydric alcohols of chain length C₄-C₁₆, sulfosuccinic acid 4-ester with polyethylene glycol ethers of monohydric aliphatic alcohols of chain length C₁₀-C₁₂ (disodium salt), sulfosuccinic acid 4-ester with polyethylene glycol nonyl phenyl ether (disodium salt), sulfosuccinic acid bis-cyclohexyl ester (sodium salt), lignosulfonic acid, and the calcium, magnesium, sodium and ammonium salts thereof, polyoxyethylene sorbitan monooleate with 20 ethylene oxide groups, resin acids, hydrogenated and dehydrogenated resin acids, and alkali metal salts thereof, dodecylated diphenyl ether disulfonic acid sodium, and copolymers of ethylene oxide and propylene oxide with a minimum content of 10% by weight ethylene oxide. As emulsifiers, preference is given to using: sodium lauryl sulfate, sodium lauryl ether sulfate, ethoxylated (3 ethylene oxide groups); the polyethylene glycol (4-20) ethers of oleyl alcohol, and the polyetene oxide (4-14) ethers of nonylphenol. The biocidal compositions according to the invention can in this connection comprise for example from 0.01 to 15% by weight, preferably from 0.02 to 8% by weight, particularly preferably from 0.05 to 6% by weight and very particularly preferably from 0,1 to 5% by weight, of emulsifiers.
Dispersants, such as, for example, alkylphenol polyglycol ethers. The biocidal compositions according to the invention can in this connection comprise for example from 0.01 to 15% by weight, preferably from 0.02 to 8% by weight, particularly preferably from 0.05 to 6% by weight and very particularly preferably from 0.1 to 5% by weight, of dispersants.
Stabilizers, such as for example cellulose and cellulose derivatives. The biocidal compositions according to the invention can here comprise for example from 0.01 to 6% by weight, preferably from 0.01 to 3% by weight, particularly preferably from 0.01 to 2% by weight and very particularly preferably from 0.01 to 1% by weight, of stabilizers.
Stabilizers, such as, for example, antioxidants, free-radical scavengers or UV absorbers.
Adhesives or protective colloids, such as for example carboxymethylcellulose, natural and synthetic pulverulent, granular or latex-like polymers, such as gum arable, polyvinyl alcohol, polyvinyl acetate, and also natural phospholipids, such as cephalins and lecithins and synthetic phospholipid, and paraffin oils. The biocidal compositions according to the invention can comprise here for example from 0.01 to 8% by weight, preferably from 0.05 to 4% by weight, particularly preferably from 0.2 to 3% by weight and very particularly preferably from 0.2 to 2% by weight, of adhesives.
Spreading agents, such as, for example, isopropyl myristate, polyoxyethylene nonyl phenyl ether and polyoxyethylene lauryl phenyl ether. The biocidal compositions according to the invention can here comprise for example from 0.01 to 20% by weight, preferably from 0.1 to 10% by weight, particularly preferably from 0.1 to 5% by weight and very particularly preferably from 0.1 to 2% by weight, of spreading agents.
Fragrances and dyes, such as, for example, inorganic pigments, for example iron oxide, titanium oxide, Prussian blue and organic dyes, such as alizarin, azo and metallophthalocyanine dyes and trace nutrients such as salts of iron, manganese, boron, copper, cobalt, molybdenum and zinc. The biocidal compositions according to the invention can here comprise for example in each case from 0.001 to 4% by weight, preferably from 0.01 to 1% by weight, particularly preferably from 0.01 to 0.8% by weight of fragrances and dyes.
Buffer substances, buffer systems or pH regulators. The biocidal compositions according to the invention can here comprise for example in each case from 0.01 to 10% by weight, preferably from 0.1 to 5% by weight, of buffer substances, buffer systems or pH regulators,
Thickeners, such as, for example, polysaccharides, xanthan gum, sodium or magnesium silicates, heteropolysaccharides, alginates, carboxymethylcellulose, gum arabic or polyacrylic acids, preferably xanthan gum.
Dedusting agents are for example polyglycols and polyglycol ethers. The biocidal compositions according to the invention can here comprise for example in each case from 0.01 to 2% by weight, preferably from 0.05 to 1% by weight, particularly preferably from 0.1 to 0.5% by weight, of dedusting agents.
Flow agents or release agents that can be used are, for example, highly disperse silica or Mg salts of fatty acids. The biocidal compositions according to the invention can here comprise in each case from 0.01 to 5% by weight, preferably from 0.05 to 3% by weight, particularly preferably from 0.1 to 2% by weight, of flow agents for improving the flowability of the solids.
Pack preservatives are, for example, biocides, bactericides and fungicides. The biocidal compositions according to the invention can here comprise for example in each case from 0.01 to 2% by weight, preferably from 0.05 to 1% by weight, of pack preservatives.

The total content of the aforementioned auxiliaries in the biocidal compositions is, for example, from 0.001 to 20% by weight, preferably from 0.1 to 15% by weight and particularly preferably from 0.1 to 10% by weight.

Solid formulations, such as for example powder mixtures or water-dispersible granules (WG), can also comprise, besides the particulate compounds of the formula (I), in addition solid auxiliaries such as, for example, natural rock flours, such as kaolins, clay earths, talc, marble, chalk, quartz, attapulgite, montmorillonite or diatomaceous earth or synthetic inorganic substances, such as highly disperse silica, aluminum oxide and silicates, or mixtures thereof.

The solid formulations can be obtained in a manner known per se for example by intimately mixing the microcapsules according to the invention with the solid auxiliaries or by joint comminution of solid auxiliaries with the compounds of the formula (I). Furthermore, the solid formulations can be obtained by drying, for example spray-drying, of a liquid formulation.

Preferred solid formulations comprise, for example, from 10 to 100% by weight of the microcapsules according to the invention, preferably from 15 to 98% by weight.

Liquid formulations can be, for example, suspension concentrates, dispersions, gels or pastes.

Preferred liquid formulations are preferably aqueous dispersions.

The liquid formulations such as, in particular, the dispersions can be produced in a manner known per se for example by jointly comminuting the compounds of the formula (I) and the other substances which are supposed to be present in the liquid formulation, or intimately mixing together the particulate, compounds of the formula (I) and the other substances which are supposed to be present in the liquid formulation by means of a dissolver or stirrer.

The liquid formulations generally comprise from 2 to 95% by weight, preferably from 5 to 75% by weight and very particularly preferably from 5 to 50% by weight, of the microcapsules according to the invention.

The invention furthermore relates to the use of the microcapsules according to the invention or of the biocidal compositions according to the invention for protecting technical materials, and also to technical materials comprising the biocidal compositions according to the invention or microcapsules according to the invention.

Technical materials are, for example, construction materials, wood, wood materials, wood-plastic composites, sealing compositions, joint sealants, plastics, films, stone slabs, textiles such as, for example, maps and tents, textile composites, coating compositions such as, for example, paints, wall paints, renderings, exterior paints, interior paints, emulsion paints, silicate paints, lacquers, concrete, cement, mortars or plasters, preferably silicate-bonded, mineral, resin-bonded or silicone-resin-bonded plasters, synthetic resin plasters, wood coatings, wood varnishes, concrete coatings, roof tile coatings, sealing compositions or textile coatings.

Further applications for coating compositions according to the invention can also be found, as well as in the construction industry, in medical technology, the textile industry, rubber industry, sealant industry, agricultural industry and laboratory technology.

The advantage of the invention is considered to be the fact that the microcapsules according to the invention exhibit a superior, because reduced, leaching behavior. It is thus possible, according to the invention, both to use smaller quantitative amounts for protecting coating compositions, and also to achieve considerably longer action times.

The examples below illustrate the present invention.

### EXAMPLES

The following substances were used for producing the diuron-containing microcapsules used in the examples which follow:

| Name | Amount |
|---|---|
| Gum arabic solution (4% by weight) | 33.75 g |
| Coadis ™ BR3 (50% by weight in H₂O) (dispersion reagent; | 6.75 g |
| aqueous polyacrylate salt solution from Coatex) | |
| Water | 451.5 g |
| SILOFOAM ®SRE (silicone-antifoarn emulsion antifoam from | 2.7 g |
| Wacker) | |
| Diuron | 135 g |
| Maprenal ®/water solution (1:1) (Maprenal ® MF 921w/85WA | 135 g |
| melamine-formaidehyde binder from MOS, Melamines) | |
| Soprophor ® S25 (emulsifier based on tris-sterylphenyl ether | 2.26 g |
| ethoxylates) | |
| Preventol ® D7 (pack preservative with about 1.5% by weight | 0.75 g |
| chloromethylisothiazolinoneimethylisothiazolinone 3:1) | |
| Preventol ® BIT 20D (pack preservative with about 20% by | 0.72 g |
| weight benzisothiazolinone) | |
| Rhodopol-G ® (thickener based on xanthen gum from Solvay | 1.20 g |
| Rhoda) | |
| Urea | 37.65 g |

Procedure of Leaching Test for Diuron-Containing Microcapsules:

In a 100 ml screw-cap jar, an amount of the formulation was weighed in which comprises 280 ppm of diuron (based on 100 g), and topped up to 100 g with water. The screw-cap jar was closed and the sample was shaken on an orbital shaker at 250 revolutions per minute and 20° C. After 24 hours (24 h leaching test) and 96 hours (96 h leaching test), 1 ml sample was taken with a pipette and transferred to a reaction vessel. The sample was centrifuged for 6 minutes at 14 000 revolutions per minute and the supernatant was analyzed by means of high performance liquid chromatography.

Preparation of the Diuron Suspension:

The diuron suspension for Examples 1 to 6 is prepared as follows:

Suspension generation: In a 1000 ml stainless steel beaker, the amounts given above of gum arabic solution, Coadis® BR3 solution and water were introduced at a room temperature with antifoam Silfoam® SRE. By adding citric acid solution (50% by weight), the pH was adjusted to 2.99. Then, diuron was added with stirring and thoroughly mixed for 30 minutes using a stirring rod (Ultra-Turrax). The crude batch was transferred to a 1000 ml flat-flange pot and heated to the deposition temperature of 60° C.

Parameter Determination:

Determination of the microcapsule size was by means of laser diffraction. For this, the following instruments and settings were used:

| | |
|---|---|
| Instrument: | LS 13 320 Particle Size Analyzer from Beckmann |
| | Coulter with PIDS technology (Polarization |
| | Intensity Differential Scattering technology) |
| Sample module: | Universal Liquid Module (ULM) |
| Illuminating source: | Diffraction: Solid State (780 nm); PIDS: tungsten |
| | lamp with bandpass filter (450, 600 and 900 nm) |
| Measurement time: | 90 seconds |
| Calculation: | Fraunhofer model |
| Result: | Diameter D90% of the volume distribution |

### Examples 1-4

### Preparation of Diuron-Containing Microcapsules With Addition of Urea During the Formulation

Deposition: At the deposition temperature of 60° C., a Maprenal/water solution (1:1) was added dropwise to the diuron suspension over a period of 2 hours.

Treatment: After the addition was complete, the mixture was heated to the respective treatment temperature and stirred for 4 hours.
Example 1: treatment temperature 70° C.
Example 2: treatment temperature 80° C.
Example 3: treatment temperature 85° C.

Then, the batch was cooled to room temperature and further stirred for 12 hours. The pH was then adjusted to pH 8 by adding sodium hydroxide solution (50% by weight).

Formulation: Then, the amounts of Soprophor® S25, Preventol® D7, Preventol® BIT 20D, Rhodopol-G® and urea given above were added.

TABLE 1
Release of diuron (in ppm) from microcapsules (produced from a formulation
comprising 280 ppm diuron and urea and treatment at different temperatures
(Temp.) according to Examples 1 to 3) directly after production
after leaching for 24 hours and 96 hours.

| | 24 h leaching test | | | | | | 96 h leaching test | | | | | |
|---|---|---|---|---|---|---|---|---|---|---|---|---|
| | Storage temperature | | | | | | | | | | | |
| | RT | | | 54° C. | | | RT | | | 54° C. | | |
| Temp. [° C.] | 70 | 80 | 85 | 70 | 80 | 85 | 70 | 80 | 85 | 70 | 80 | 85 |
| Direct | 6.9 | 1.9 | 1.5 | 6.9 | 1.9 | 1.8 | 19.3 | 4.7 | 3.8* | 19.3 | 4.7 | 3.8* |
| measurement | | | | | | | | | | | | |
| 2 weeks | | | | 3.6 | 2.9 | 2.9 | | | | 8.6 | 5.3 | 4.8 |
| 1 month | 7.5 | 2.3 | 2.1 | 4.1 | 2.8 | 3.8 | 23.8 | 4.6 | 3.7 | 9.6 | 5.3 | 4.7 |

*Leaching after 72 h

Particle sizes after production according to Example 2: D90=29.75 mm

Particle sizes after production according to Example 3: D9=29.46 mm

Example 4: Example 4 differs from Example 3 merely in that
the Maprenal®/water solution (1:1) was added over a period of 3 hours instead of 2 hours to the diuron suspension,
the heating at a treatment temperature of 85° C. is carried out for 20 hours instead of 4 hours and
the batch after cooling to room temperature was further stirred for 2 hours instead of 12 hours.

| | 24 h leaching test | 96 h leaching test | 192 h leaching test |
|---|---|---|---|
| | Storage temperature | | |
| | RT | RT | RT |
| Temp. [° C.] | 85 | 85 | 85 |
| Direct | 0.7 | 1.0 | 1.9 |
| measurement | | | |

### Example 5

Production of Diuron-Containing Microcapsules With the Addition of Urea Directly Prior to Treatment

Example 5 differs from Example 2 exclusively by virtue of a different addition timepoint of the urea.

Deposition: At the deposition temperature of 60° C., a Maprenal®/wafer solution (1:1) was added dropwise to the diuron suspension over a period of 2 hours. Then, urea is added.

Treatment: After the addition was complete, the mixture was heated to 80° C. and stirred for 4 hours. The batch was then cooled to room temperature and further stirred for 12 hours. The pH was then adjusted to pH 8 by adding sodium hydroxide solution (50% by weight).

Formulation: Then, the amounts of Soprophor® S25, Preventol® D7, Preventol® BIT 20D and Rhodopol-G® given above were added.

TABLE 2
Release of diuron from microcapsules (produced from
a formulation comprising 280 ppm diuron and urea
according to Example 5) after leaching for 24 hours.

| Storage | Storage temperature [° C.] | Diuron [ppm] |
|---|---|---|
| Direct measurement | 21 | 24.8 |

### Example 6

### Production of Diuron-Containing Microcapsules With the Addition of Urea Directly After Treatment

Example 6 differs from Example 2 exclusively by virtue of a different addition timepoint of the urea.

Deposition: At the deposition temperature of 60° C., a Maprenal®/water solution (1:1) was added dropwise to the diuron suspension over a period of 2 hours.

Treatment: After the addition was complete, the mixture was heated to 80° C. and stirred for 4 hours at 80° C. Urea was then added. Then, the batch was cooled to room temperature and further stirred for 12 hours. The pH was then adjusted to pH 8 by adding sodium hydroxide solution (50% by weight).

Formulation: Then, the amounts of Soprophor® S25, Preventol® D7, Preventol® BIT 20D, and Rhodopol-G® given above were added.

TABLE 3
Release of diuron from microcapsules (produced from
a formulation comprising 280 ppm of diuron and urea
according to Example 6) after leaching for 24 hour.

| Storage | Storage temperature [° C.] | Diuron [ppm] |
|---|---|---|
| Direct measurement | 21 | 18 |

### Example 7

### Influence of the Treatment Time

Deposition: At the deposition temperature of 60° C., a Maprenal®/water solution (1:1) was added dropwise to the diuron suspension over a period of 2 hours.

Treatment: After the addition was complete, the mixture was heated to the respective treatment temperature and stirred for the respective treatment time. The batch was cooled to room temperature and further stirred for 12 hours. The pH value was then adjusted to pH 8 by adding sodium hydroxide (50% by weight).

Formulation: Then, the amounts of Soprophor® S25, Preventol® D7, Preventol® BIT 20D, Rhodopol-G® and urea given above were added.

TABLE 4
Release of diuron from microcapsules (produced from
a formulation comprising 280 ppm of diuron and urea
(Example 7)) after leaching for 24 hours.

| Treatment time | Treatment temperature | Diuron |
|---|---|---|
| [hours] | [° C.] | [ppm] |
| 1 | 85 | 3.6 |
| 2 | 85 | 3.9 |
| 3 | 85 | 2.5 |
| 4 | 85 | 1.5 |

The algae toxicity measurements were carried out in accordance with OECD Guideline 201 (Mar. 23, 2006).

Influence of the Treatment Temperature on the Algae Toxicity Measurement

| | Treatment temperature [° C.] | |
|---|---|---|
| | 70 | 80 |
| Urea | + | |
| EC50 [mg/l] | 0.91 | 2.653 |

Influence of Urea on the Algae Toxicity Measurement

| | Treatment temperature [° C.] | |
|---|---|---|
| | 70 | |
| Urea | + | − |
| EC50 [mg/l] | 0.91 | 3.384 |

The EC50 value is understood as meaning the half-maximum effective concentration of the formulation. The concentration data refers to the amount of formulation per liter.

1. A microcapsule comprising:
at least one compound of the formula (I) 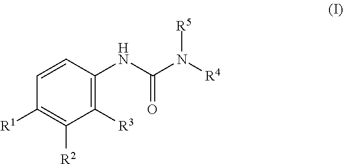
where
R¹ and R², independently of one another, are hydrogen, chlorine, bromine, alkyl, alkoxy, trifluoromethyl or aryloxy,
R³ is hydrogen, chlorine, bromine, fluorine or alkyl, and
R⁴ and R⁵, independently of one another, are alkyl or alkoxy; and
microencapsulation material disposed at least partially about the at least one compound of the formula (I), wherein the microencapsulation material comprises at least one melamine-formaldehyde polymer.

2. The microcapsule as claimed in claim 1, wherein:
the alkyl is at least one of branched (C₁-C₁₀)-alkyl, straight-chain (C₁-C₁₀)-alkyl cyclic (C₁-C₁₀-alkyl, and acyclic (C₁-C₁₀)-alkyl,
the alkoxy is at least one of branched (C₁-C₁₀)-alkoxyl, straight-chain (C₁-C₁₀)-alkoxy, cyclic (C₁-C₁₀)-alkoxy, and acyclic (C₁-C₁₀)-alkoxy, and
the aryloxy is at least one of phenoxy and phenoxy substituted by alkoxy.

3. The microcapsule as claimed in claim 1, wherein, compounds of the formula (I) are selected from a group that includes 3-(4-bromo-3-chlorophenyl)-1-methoxy-1-methylurea (chlorbromuron), 3-(3-chloro-4-methylphenyl)-1,1-dimethylurea (chlortoluron), 3-(3,4-dichlorophenyl)-1,1-dimethylurea (diuron), 3-(4-(4-methoxyphenoxy)phenyl)-1,1-dimethylurea (difenoxuron), 1,1-dimethyl-3-[3-(trifluoromethyl)phenyl]urea (fluometuron), 3-(4-isopropylphenyl)-1,1-dimethylurea (isoproturon) and 1-butyl-3-(3,4-dichlorophenyl)-1-methylurea (neburon).

4. The microcapsule as claimed in claim 1, wherein the microcapsule has a volume-averaged particle size of 0.3 to 100 μm.

5. The microcapsule as claimed in claim 1, wherein the microencapsulation material additionally comprises at least one of synthetic aminoplast resins, semisynthetic aminoplast resins, natural aminoplast resins.

6. The microcapsule as claimed in claim 1, wherein the microcapsule has a 24 h leaching rate of 0.1 to 9.0 parts per million (ppm) to the encapsulated compound of formula (I).

7. A method for the production of the microcapsules as claimed in claim 1, the method comprising of contacting the microencapsulation material and the at least one compound of the formula (I) at a temperature and for a period of time sufficient to at least partially solidify the microencapsulation material about at least a portion of the at least one compound of the formula (I).

8. The method as claimed in claim 7, wherein the contacting comprises heating at temperatures of 50 to 95° C. over a period of at least one hour.

9. The method as claimed in claim 7, wherein the contacting comprises:
forming a suspension or emulsion containing the at least one compound of the formula (I) and the melamine-formaldehyde polymer, and
heating the suspension to a deposition temperature of 50 to 95° C. to at least partially solidify the microencapsulation material about at least a portion of the at least one compound of the formula (I).

10. The method as claimed in claim 9, further comprising adding urea to the suspension or emulsion at at least one of:
before or after deposition of the microencapsulation material on the compound of the formula (I); and
before or after heating of the suspension or emulsion.

11. The method as claimed in claim 7, wherein the method comprises:
forming a suspension or emulsion containing the at least one compound of the formula (I),
adjusting the pH of the suspension or emulsion to form a pH adjusted mixture,
heating the pH adjusted mixture to a deposition temperature of 50 to 95° C., and
adding the melamine-formaldehyde polymer to the heated mixture.

12. A biocidal composition comprising the microcapsule as claimed in claim 1.

13. A method for destroying, deferring, rendering harmless, or exerting a controlling effect on photoautographic microorganisms, the method comprising contacting the photoautographic microorganisms with a biocidal composition comprising the microcapsule as claimed in claim 1.

14. A technical material comprising the biocidal composition as claimed in claim 12.

15. A method for protecting technical materials from harmful organisms, the method comprising incorporating the microcapsule as claimed in claim 1 with the technical materials to be protected.

16. The microcapsule as claimed in claim 1, wherein:
the microcapsule has a volume-averaged particle size of 0.3 to 100 μm;
the compounds of the formula (I) are selected from a group consisting of 3-(4-bromo-3-chlorophenyl)-1-methoxy-1-methylurea, 3-(3-chloro-4-methylphenyl)-1,1-dimethylurea, 3-(3,4-dichlorophenyl)-1,1 -dimethylurea, 3-(4-(4-methoxyphenoxy)phenyl)-1,1-dimethylurea, 1,1-dimethyl-3-[3-trifluoromethyl)phenyl]urea, 3-(4-isopropylphenyl)-1,1-dimethylurea and 1-butyl-3-(3,4-dichlorophenyl)-1-methylurea; and
a weight ratio (w/w) of the microencapsulation material to compounds of the formula (I) in the microcapsules is from 1:100 to 100:1.

17. The microcapsule as claimed in claim 18, wherein:
the microcapsule has a volume-averaged particle size of 5 to 40 μm;
the microcapsule has a 24 h leaching rate of lass than 2.5 parts per million (ppm) with respect to the encapsulated compound of formula (I); and
the microencapsulation material additionally comprises up to 50% by weight of at least one additional resin selected from a group that includes synthetic aminoplastic resins, semisynthetic aminoplastic resins, natural aminoplastic resins, melamine-formaldehyde resins modified with urea or phenol, aminoplast resins of an NH-group-containing compound and acetaldehyde or glyoxal, urethane resins, cyanamide resins, or dicyanamide resins, aniline resins, and sulfonamide resins, or mixtures of these resins.

18. The microcapsule as claimed in claim 17, wherein:
the compound of the formula (I) is 3-(3,4-dichlorophenyl)-1,1-dimethylurea;
the microencapsulation material comprises at least 95% by weight melamine-formaldehyde polymer;
the synthetic aminoplastic resins include acrylic polymers and copolymers, polyacrylamide, polyalkyl cyanoacrylate, and polyethylene vinyl acetate), aluminum monostearate, carboxyvinyl polymers, polyamides, poly(methyl vinyl ether-maleic anhydride), poly(adipyl-L-lysine), polycarbonates, polyterephthalamide, poly(vinyl acetate phthalate), poly(terephthaloyl-L-lysine), polyarylsulfones, poly(methyl methacrylate), poly(ε-caprolactone), polyvinylpyrrolidone, polydimethylsiloxane, polyoxyethylenes, polyesters, polyglycolic acid, polylactic acid and copolymers thereof, polyglutamic acid, polylysine, polystyrene, poly(styrene-acrylonitrile), polyimides and polyvinyl alcohol;
the semisynthetic aminoplastic resins include cellulose acetate, cellulose acetate butyrate, cellulose acetate phthalate, cellulose nitrate, ethylcellulose, hydroxypropylcellulose, sodium carboxymethylcellulose, hydroxypropylmethylcellulose, methylcellulose, hydroxypropylmethylcellulose phthalate, hydrogenated tallow, myristyl alcohol, glycerol mono- or dipalmitate, hydrogenated castor oil, glyceryl mono- and tristearates and 12-hydroxystearyl alcohol; and
the natural aminoplastic resins include gum arabic, agar, agarose, maltodextrin, sodium alginate, calcium alginate, dextran, fats, fatty acids, cetyl alcohol, milk solids, molasses, gelatin, gluten, albumin, shellac, starches, caseinates, stearins, saccharose, and waxes.

19. The method as claimed in claim 7, wherein the contacting comprises heating at temperatures of 80 to 90° C. over a period of 2 to 8 hours.
